(19) United States
(12) Patent Application Publication
(10) Pub. No.: US 2023/0333639 A1
(43) Pub. Date: Oct. 19, 2023

(54) SYSTEM, METHOD, AND APPARATUS, AND METHOD FOR A DIGITAL AUDIO READING AND VISUAL READING ASSISTANT THAT PROVIDES AUTOMATED SUPPLEMENTAL INFORMATION

(71) Applicant: Rinaldo S. DiGiorgio, Neavitt, MD (US)

(72) Inventor: Rinaldo S. DiGiorgio, Neavitt, MD (US)

(21) Appl. No.: 17/659,378

(22) Filed: Apr. 15, 2022

(51) Int. Cl. G06F 3/01; G06V 30/262; G06T 11/60

(52) U.S. Cl. CPC G06F 3/013; G06V 30/274; G06T 11/60

(57) ABSTRACT

System, method, and apparatus, for a digital assistant that provides automated supplemental information based on a detected knowledge gap or interest of the user. The system includes an eye tracking hardware component, having one or more sensors, and an eye tracking software component to detect eye movements of the user while reading information presented on the display and detect an eye movement event indicative of a knowledge gap or interest of the user. A UCAS Personal Knowledge Agent (PKA) is an artificial intelligence (AI) component is configured to provide real time supplemental information, or supplemental audio, to facilitate the user's understanding of the presented information upon detection of the eye movement event.

### BACKGROUND OF THE INVENTION

The present invention relates to, and more particularly to a digital audio reading and visual reading assistant and, more particularly, to a digital audio reading and visual reading assistant that provides automated information. Automated meaning no user input required, other external inputs are used. Digital Reading encompasses text, and images and in some cases interactive media like an interactive text book. The invention applies to eBook formats like Kindle and Nook as well as Apple books with or without a physical reading device.

When a user is listening to some audio stream or reading digital content, or reading code using an IDE like Eclipse or Visual Code, acquiring supplemental data in real-time requires the user to stop what they are doing and search for the data. Current devices are not automated and require the user to select words in the case of digital reading. People are experiencing high cognitive loads, and people need to recall more. Computers are better at recall than humans. Current approaches require the user to use some device and perform actions like searching while reading or listening.

As can be seen, there is a need for a digital audio reading and visual reading assistant that provides supplemental information automatically.

### SUMMARY OF THE INVENTION

In one aspect of the present invention, a system for providing automated supplemental information to a user consuming a digital content is disclosed. The system includes an eye movement tracking apparatus configured to detect an eye movement event associated with a user's eye movements while consuming a presented information contained within the digital content. The eye movement event is indicative of a knowledge gap or an interest of the user when encountering an information element in the presented information. A content management service is configured for ingesting the digital content encountered by the user. A personal knowledge assistant (PKA) is configured to analyze an ingested digital content consumed by the user to develop a knowledge profile of the user. A semantic processing engine is configured to processes the presented information and determine a context for the presented information. The PKA further generates a supplemental information based on an intersection of the knowledge profile, the knowledge gap, and the context of the presented information. An application program interface (API) communicates the supplemental information to a display viewable by the user.

In some embodiments, the eye movement event includes one or more of a pause and a wandering.

In some embodiments, the eye movement tracking apparatus may be a wearable head gear having one or more sensors to detect a position and a movement of the user's eyes. The eye movement tracking apparatus may also include the display.

In some embodiments, the ingested digital content includes one or more of a browser activity, a personal video, a data storage repository of the user, a video content viewed by the user, an audio listened to by the user, and one or more purchases of the user.

In some embodiments, an optical character recognition (OCR) module is configured to recognize a text content contained within the presented information, when the digital content is presented as an image content. An output of the OCR module is provided to the semantic processing engine.

In some embodiments, the eye movement tracking apparatus correlates an eye position of the user with an information element in the presented information.

In other aspects of the invention, a computer implemented method for providing automated supplemental information to a user consuming a digital content. The method includes tracking, via an eye movement tracking apparatus, an eye movement of a user while consuming a presented information contained within the digital content. An eye movement event associated with a user's eye movements, is detected. The eye movement event indicative of a knowledge gap or an interest of the user when encountering an information element in the presented information. A content management service ingests the digital content encountered by the user. A personal knowledge assistant (PKA) analyzes an ingested digital content consumed by the user. The PKA develops a knowledge profile of the user based on the ingested digital content. A semantic processing engine processes the presented information and determines a context for the presented information. The PKA generates a supplemental information based on an intersection of the knowledge profile, the knowledge gap, the interest of the user, and the context of the presented information. The supplemental information is communicated to a display viewable by the user, via an application programming interface (API).

In some embodiments, the eye movement event includes one or more of a pause and a wandering. The eye movement tracking apparatus may be a wearable head gear having one or more sensors to detect a position and a movement of the user's eyes. The eye movement tracking apparatus may also include the display.

In some embodiments, the ingested digital content includes one or more of a browser activity, a personal video, a data storage repository of the user, a video content viewed by the user, an audio listened to by the user, and one or more purchases of the user.

In some embodiment, the method includes performing an optical character recognition (OCR) to recognize a text content contained within the presented information when the digital content is presented as an image content.

In some embodiments, the method includes providing an output of the OCR to the semantic processing engine.

In other embodiments, the method includes correlating an eye position of the user with an information element in the presented information.

These and other features, aspects and advantages of the present invention will become better understood with reference to the following drawings, description and claims.

### BRIEF DESCRIPTION OF THE DRAWINGS

FIG. 1 is a schematic view of the devices used with the system.

FIG. 2 is a schematic view of an eye movement tracking apparatus with embedded display.

FIG. 3 is a schematic view of the Undirected Content Augmentation Service (UCAS) cloud services.

FIG. 4 is a schematic view of the UCAS cloud services model.

FIG. 5 is a schematic view of the elements of the UCAS.

FIG. 6 is a schematic view of the a process flow UCAS content management, semantic processing unit, and API presentation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product that provides Undirected Content Augmentation Service (UCAS). While reading or listening to digital content, users receive supplemental information requiring no action from the user from the digital audio reading and visual reading assistant. The present invention provides automated unsolicited digital assistance to the user when reading digital material on a display, such as a laptop 10, an LCD display 12, or a portable computing device 14, such as a tablet or a smartphone. The user may also be participating in some audio-based scenario.

Components of UCAS detect pauses and wanderings of the user's eyes with an eye tracking hardware component 22, having one or more sensors 24, 26 and an eye tracking software component receiving inputs from the one or more sensors 24, 26 to detect eye movements of the user while reading information presented on the display 12, 12, 14. When the eye tracking component detects one or more of these events, supplemental information is provided to the user to facilitate a better understanding and comprehension of the information presented.

For example, when the eye tracking component detects a pause over certain content of the presented information, which may be a particular word, a phrase, a graphic, or the like, the supplemental information may include a definition of the particular word, a meaning of the phrase, an identification of characteristics or meaning of the graphic. The supplemental information may be presented as an information presentation element on the display 10, 12, 14, such as a popup proximal to the information presented, or as an information presentation element at the point of the pause or in a path of the wanderings. Alternatively, UCAS may show the information presentation element in an optical display component of the eye tracking hardware component 22.

In certain embodiments, the user's personal digital history may be used to determine the relevance of what supplemental information to show in the information presentation element.

UCAS may employ similar processes to listening activities. The listening user does not have to take any physical activity to get a definition for a word to come up that UCAS thought the user might not know. A reader pausing or daydreaming while performing digital reading, is presented with supplemental information by UCAS. Other devices are not automatic and don't combine the user's personal history with the eye tracker, audio stream and software processing of both private and public data feeds.

The present invention includes UCAS software loaded on a computing system. The computing system 10 is at least the processor and the memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for user communication with the computing system. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computing system and one or more other computing systems or one or more networks. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing system may include any suitable communication interface for any of these networks, where appropriate.

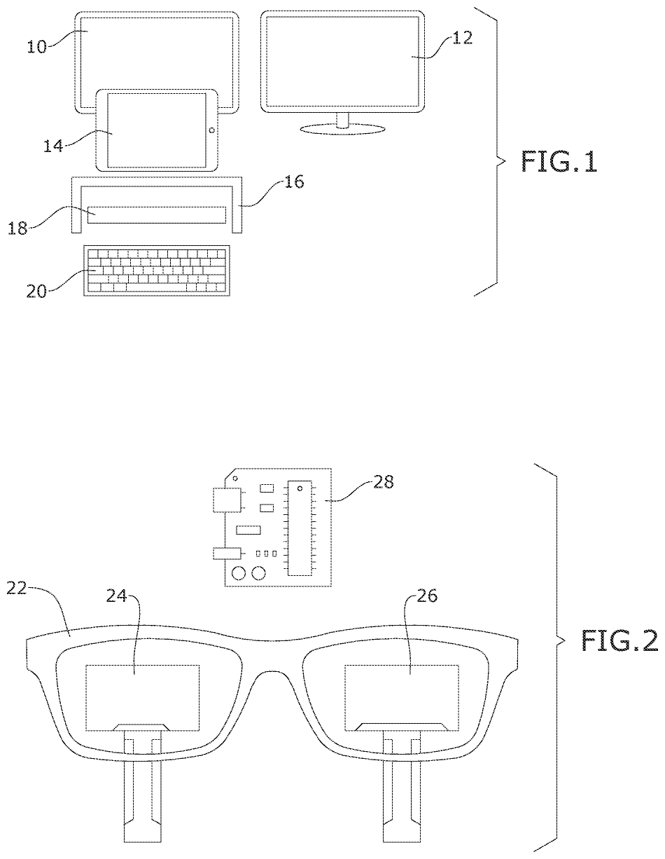

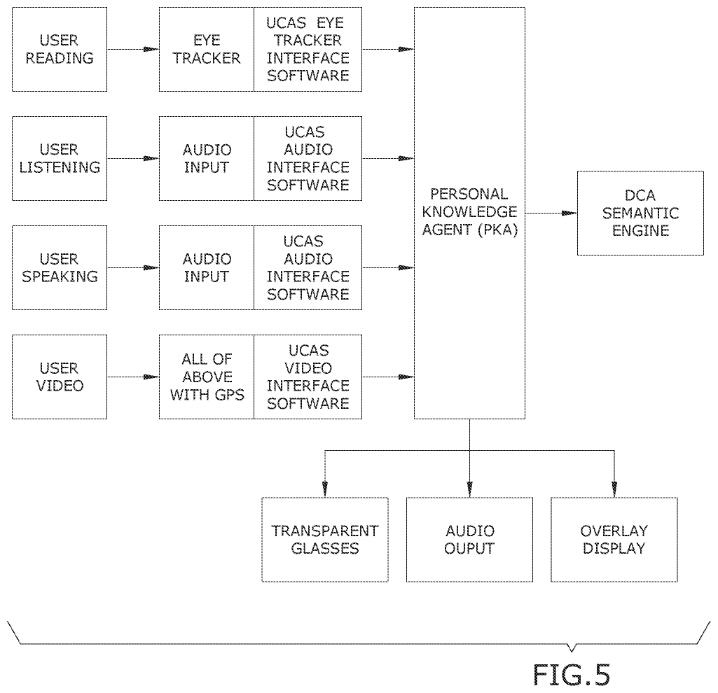

Referring now to FIGS. 1 through 6, the present invention may include the following:

An eye tracker may include an eye tracking hardware component 22, a UCAS eye tracking software component, and an eye tracking processing component 28. The eye tracking hardware component 22 may be implemented with an eyewear, such as glasses, virtual reality goggles, and the like. By way of non-limiting example, the eye tracking hardware component 22, may include a Tobii Pro X3-120—120 Hz, Tobii Pro TX 300 Eye Tracker, Tobii Pro T60 XL—60 Hz, Tobii Pro Spectrum—150/300/600 Hz, Tobii Pro Eye Tracking Glasses 2—50/100 Hz (Wireless), Seeing Machines face LAB 5, SMI RED-m—60 Hz/120 Hz (SMI Acquired by Apple), Eye Link 1000 Eye Tracker—500/1000/2000 Hz, LC Technologies Eye Follower, Smart Eye Pro Eye Tracker—60 Hz/120 Hz, Smart Eye Pro dx, Ergoneers Dikablis Professional Glasses—60 Hz, SMI Eye Tracking Glasses—120 Hz (SMI Acquired by Apple), Tobii Pro VR Integration based on HTC Vive HMD—120 Hz, Smart Eye Aurora—60 Hz, Tobii Pro X2-60 (no longer sold), Varjo VR-1 VR headset).

As seen in reference to FIG. 4, A UCAS Personal Knowledge Agent (PKA) is an artificial intelligence (AI) component that is configured to provide real time supplemental information, or supplemental audio, to facilitate the user's understanding of the presented information. The supplemental information may be derived from a variety of sources to augment the user's level of comprehension, vocabulary understanding, or technical, artistic, or knowledge levels.

The PKA is able to ascertain words, topics, and/or images from the presented information that the user may need the supplemental information for better understanding. The PKA includes including a cognitive processing module, such as Watson Natural Language Understanding; a natural language processing module, such as AWS Comprehend—Natural Language Processing, an open artificial intelligence application programming interface (API), a Teradata parallel transporter TPT-N; the Pile, a 825 GiB diverse open source language modelling data set; one or more mind maps; one or more topic maps; a social media presence of the user; one or more private files of the user; and a user's browsing history.

The UCAS PKA creates scenarios automatically based on the user's activities and uses techniques to build a datastore that has information about this user and categorizes the activity and links data specific to that activity, For example, a user can be reading, coding, working in the garden, working in the woodshop and so on without many limits as to where and how it is used. If the user is mobile the user may be wearing a device, if the user is using a desktop the same concepts apply and the data is overlaid on the existing view.

User data is sent to the UCAS PKA and UCAS responds with annotations or other data. When data is sent to the UCAS PKA, the UCAS system processes the requests using one or more plugins to determine an optimal response for the user. Each of these activities is initially achieved with one or more recording plugins. A shortlist of some plugins to tools that are activated by requests from the user may include: answer questions based on users existing knowledge; grammar correction; correct sentences into standard English; summarized for a specified reading level; translate difficult text into simpler concepts; natural language to Open AI API; text to command; translate text into programmatic commands; English to other languages; create code to call the Stripe API using natural language; classification; classify items into categories via example; explain a piece of computer code in human understandable language; calculate time complexity, find the time complexity of a function; translate programming languages; advanced tweet classifier; advanced sentiment detection for a piece of text; keywords; extract keywords from a block of text; factual answering.

As time goes on, custom more advanced plugins can be plugged in to provide more detail, for example, looking at a flower that the user is considering for beauty or for understanding. The PKA may support simple gestures like a tap to mute or a command like stop/next, augmenting or a rapid eye movement to the right or left from the control of the information presented. The Eye-tracking software can decode and translate eye movement actions like up, down, left, right, and user-definable yes and no very similar to touch gestures.

In a non-limiting example, the UCAS PKA service is described in further detail in connection with the user reading a sentence over and over and not understanding the sentence. As the user is reading an eBook and this particular eBook producer doesn't allow access to the material via API. As the user is reading the eBook, the UCAS PKA service performs an optical character recognition (OCR) on the presented content and converts the text. When the eye tracking component detects that the user pauses on the following sentence, (taken from Open AI Page)
Jupiter is the fifth planet from the Sun and the largest in the Solar System. It is a gas giant with a mass one-thousandth that of the Sun, but two-and-a-half times that of all the other planets in the Solar System combined. Jupiter is one of the brightest objects visible to the naked eye in the night sky, and has been known to ancient civilizations since before recorded history. It is named after the Roman god Jupiter.[19] When viewed from Earth, Jupiter can be bright enough for its reflected light to cast visible shadows,[20] and is on average the third-brightest natural object in the night sky after the Moon and Venus.

The UCAS PKA is given a request to/explain the given sentence. The UCAS PKA performs the following task Using technologies like Spacey, Open AI, and the Pile, to generate the following sample response:
Jupiter is a planet that is bigger than all the other planets in our solar system and is very bright when you see it in the night sky. It is named after the Roman god Jupiter. When viewed from Earth, it is usually one of the three brightest objects in the sky.
   The sample response in text above would be displayed in the user's glasses, audio into an earpiece, or on the screen depending on preferences and availability. A more control may be provided, that when activated, presents an additional response to the /explain.

In another non-limiting example, the UCAS PKA service may also be employed for a user giving commands to a computer using Bash. The user is entering commands into Bash and the system detections through a modular plugin that is specific to Bash or generic. When the user keeps typing commands with incorrect arguments, the UCAS PKA looks for past usages of this command by the user and or provides descriptions of the command, since the UCAS PKA is aware the user is using Bash and what it means for a custom search model. In this case, the UCAS PKA is augmented with a special purpose module while providing a general framework for managing what type of information the user is looking for in this case.

In another non-limiting example, the UCAS PKA service is described for a user taking a course on COURSERA about Deep Neural Networks. In this example, the UCAS PKA is a service bound to a user. The PKA has personal private information and learnings based on a user. The PKA provides an API and generates events based on synchronous requests.

In this case of the user reading a very technical document and being new to the material and seeing terms like the following RELU, Tensor, SoftMax. For the case of the eye detector noticing, the user is pausing on the above terms. The following events take place in the UCAS PKA. A request is made using the PKA API with a call like/augment/term. The POST details contain information like the term, in this case, RELU, where a link to the text the user is looking at if they are in a browser or links in APIs of other eBook formats. The UCAS PKA system is constantly saving a user's electronic actions so there is a rich personal database of what the particular user has seen or experienced in the base.

Various technologies are running in the UCAS PKA performing this task, indexing disk files of different content types, speech to text recordings of meeting a user has been in, OCR of presentations and video from glasses or other sources. Each user has a data store with single terms and multiples with very fast indexing allowing quick indexing. In this particular case, the user is taking the course on Coursera, the UCAS PKA has links to the course material and has a reading index of the material the user has been looking at and created links to statistically significant words. When the user pauses on the RELU term, the system responds with material related to the text the user was looking at since the material the user was looking at was already categorized. In this case, the user would be presented with a definition of the term in the view field

The UCAS PKA may embodied in various devices such as a UCAS enabled phone; UCAS enabled browser; the UCAS enabled glasses 22; a UCAS enabled Echo; the UCAS Enabled eye tracker; or other devices.

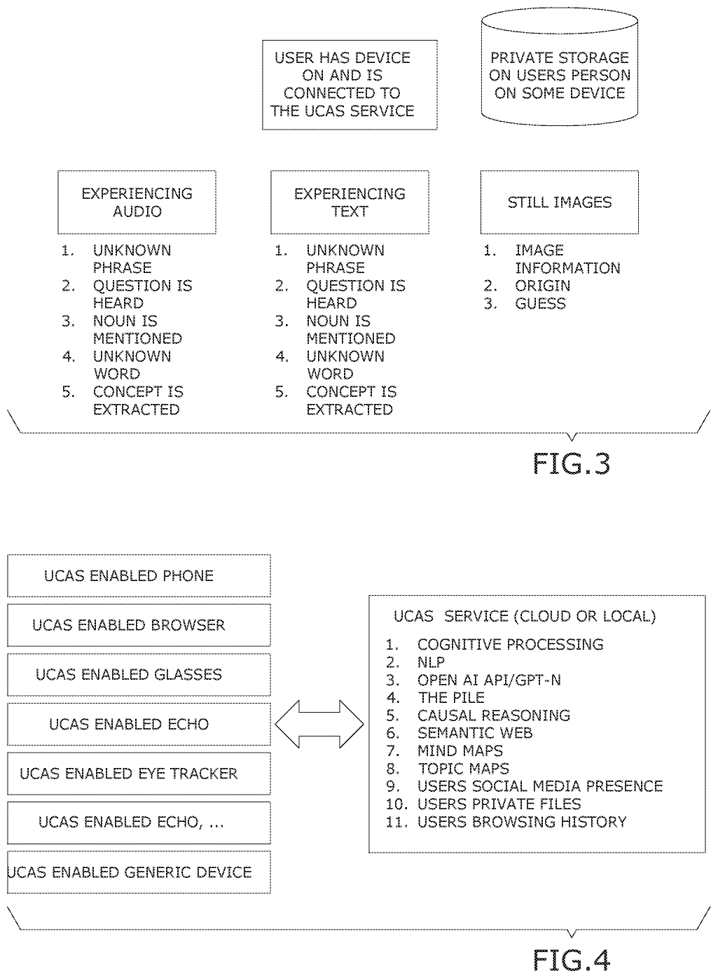

As seen in reference to FIG. 3, example use scenarios of the system are illustrated. While the user is experiencing a text content, such reading an article on a web page. The UCAS may determine an unknown phrase; a question; a noun; an unknown word, or a concept that requires extraction for the user. The enabled glasses 22 uses the eye tracker 24, 26 to determine if a user has paused or has wandered from of the presented information and communicates with the UCAS PKA to obtain the supplemental information for the user. While the user is listening to the UCAS audio interface software and the UCAS PKA determines the user might need some help with some word and proceeds to display the information on the Transparent Glasses 22, for example.

Some typical services are a dictionary, Wikipedia, Google, cloud-based audio to speech, browsing history, contents of user's private data like email, files on the disk, chats, etc. The UCAS PKA stores this data and learns from the user reaction to the information, and stores the information for future use, and learning. The UCAS software may be integrated with commercial off the shelf computing devices, eye trackers, programmable glasses, and the like. The present invention may be used for many learning tasks, including tasks where users are looking at physical devices. Existing devices like HOLOLENS™ benefit from the unprompted display of useful information to the user.

To use the present invention, a user installs the software and hardware on a computing system and begins reading or listening to digital content from the computing device. The user may further give permission to use private data. The present invention may be used to receive relevant data without requiring a prompt by the user. Additionally, the present invention can be used to decrease the amount of time it takes to train someone and can further be used to teach one in real time how to perform a complex task.

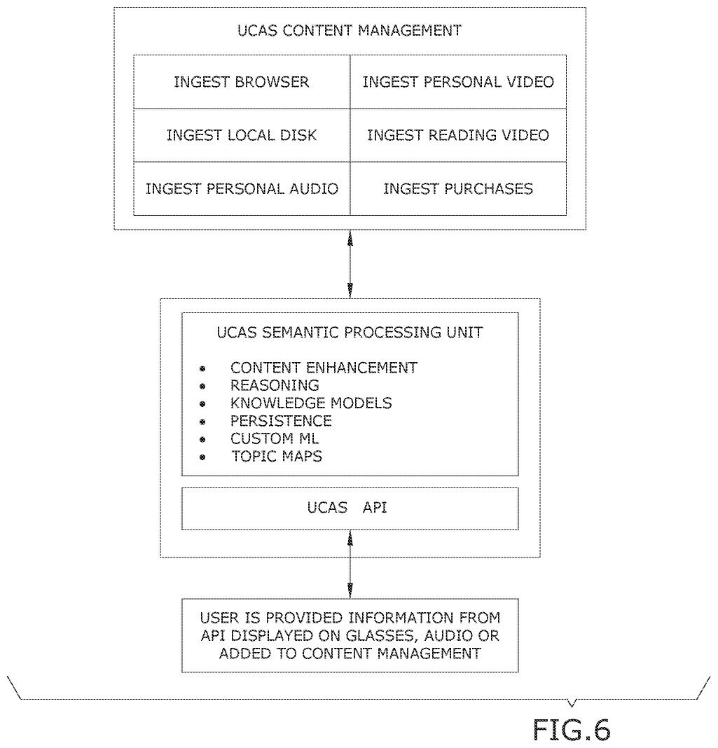

The present invention works by using a device to detect events in one case, fixations while reading and providing supplemental information, such as significant words or sentences in another. As seen in reference to FIG. 6, a content management service is configured to ingest content the user experiences. The content may include browser activity, personal video content created by the user, content save to and retrieved from the user's data storage, such as a local disk storage or cloud storage drive, video content consumed by the user, personal audio consumed, and purchases made by the user.

A UCAS semantic processing engine processes the presented information contained within the ingested content and determines a context for the presented information. The semantic processing engine determines a context based on one or more of a content enhancement, reasoning, knowledge models, persistence, customized machine learning, and topic maps, for example, and generates the supplemental content to fill a knowledge gap in the user's understanding of the presented information, or a user's interest in the presented information, indicated by the detected eye movement event. The supplemental content is provided to the user via a UCAS API, which is configured to communicate with the device through which the user is then interacting. As indicated previously, the supplemental content may be presented with a display 24, 26 integrated with the eye movement detection glasses 22, a computer display, or audio and video channels.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like,

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing automated supplemental information to a user consuming a digital content, comprising:
an eye movement tracking apparatus configured to detect an eye movement event associated with a user's eye movements while consuming a presented information contained within the digital content, the eye movement event indicative of a knowledge gap or an interest of the user when encountering an information element in the presented information;
a content management service for ingesting the digital content encountered by the user;
a personal knowledge assistant (PKA) configured to analyze an ingested digital content consumed by the user to develop a knowledge profile of the user;
a semantic processing engine configured to processes the presented information and determine a context for the presented information;
the PKA further configured to generate a supplemental information based on an intersection of the knowledge profile, the knowledge gap, and the context of the presented information; and
an application program interface (API) for communicating the supplemental information to a display viewable by the user.

2. The system of claim 1, wherein the eye movement event includes one or more of a pause and a wandering.

3. The system of claim 1, wherein the eye movement tracking apparatus comprises:
a wearable head gear having one or more sensors to detect a position and a movement of the user's eyes.

4. The system of claim 3, wherein the eye movement tracking apparatus further comprises the display.

5. The system of claim 1, wherein the ingested digital content comprises:
one or more of a browser activity, a personal video, a data storage repository of the user, a video content viewed by the user, an audio listened to by the user, and one or more purchases of the user.

6. The system of claim 1, the PKA further comprising:
an optical character recognition (OCR) module configured to recognize a text content contained within the presented information, when the digital content is presented as an image content, wherein an output of the OCR module is provided to the semantic processing engine.

7. The system of claim 1, wherein the eye movement tracking apparatus correlates an eye position of the user with an information element in the presented information.

8. A computer implemented method for providing automated supplemental information to a user consuming a digital content, comprising:
tracking via an eye movement tracking apparatus, an eye movement of a user while consuming a presented information contained within the digital content;
detecting an eye movement event associated with a user's eye movements, the eye movement event indicative of a knowledge gap or an interest of the user when encountering an information element in the presented information;
ingesting, via a content management service, the digital content encountered by the user;
analyzing, via a personal knowledge assistant (PKA), an ingested digital content consumed by the user;
developing a knowledge profile of the user, based on the ingested digital content;
processing, via a semantic processing engine, the presented information and determine a context for the presented information;
generating, via the PKA, a supplemental information based on an intersection of the knowledge profile, the knowledge gap, the interest of the user, and the context of the presented information; and
communicating, via an application program interface (API), the supplemental information to a display viewable by the user.

9. The method of claim 8, wherein the eye movement event includes one or more of a pause and a wandering.

10. The method of claim 8, wherein the eye movement tracking apparatus comprises:
a wearable head gear having one or more sensors to detect a position and a movement of the user's eyes.

11. The method of claim 10, wherein the eye movement tracking apparatus further comprises the display.

12. The method of claim 8, wherein the ingested digital content comprises:
one or more of a browser activity, a personal video, a data storage repository of the user, a video content viewed by the user, an audio listened to by the user, and one or more purchases of the user.

13. The method of claim 8, the further comprising:
performing an optical character recognition (OCR) to recognize a text content contained within the presented information when the digital content is presented as an image content.

14. The method of claim 13, further comprising:
providing and of the OCR to the semantic processing engine.

15. The method of claim 8, further comprising:
correlating an eye position of the user with an information element in the presented information.
